(19) United States
(12) Patent Application Publication
(10) Pub. No.: US 2026/0040215 A1
(43) Pub. Date: Feb. 5, 2026

(54) METHOD AND APPARATUS OF SPATIAL RELATIONS FOR A LOW POWER SYNCHRONIZATION SIGNAL IN A LOW-POWER-WAKE-UP SIGNAL (LP-WUS) SYSTEM

(71) Applicant: InterDigital Patent Holdings, Inc., Wilmington, DE (US)

(72) Inventors: Nazli Khan Beigi, Longueuil (CA); Young Woo Kwak, Woodbury, NY (US); Moon IL Lee, Melville, NY (US); Janet Stern-Berkowitz, Little Neck, NY (US); Prasanna Herath, Laval (CA); Virgile Garcia, Antibes (FR)

(73) Assignee: InterDigital Patent Holdings, Inc., Wilmington, DE (US)

(21) Appl. No.: 18/794,317

(22) Filed: Aug. 5, 2024

(51) Int. Cl. H04W 52/02; H04L 5/00; H04W 24/08

(52) U.S. Cl. CPC H04W 52/0229; H04L 5/0051; H04L 5/0094; H04W 24/08

(57) ABSTRACT

A wireless transmit/receive unit (WTRU) receives configuration information for a first low power synchronization signal (LP-SS) and a set of candidate LP-SSs. The first LP-SS and the set are associated with a low-power-wake-up signal (LP-WUS). The WTRU determines a spatial filter for receiving the first LP-SS, and receives the first LP-SS. The WTRU measures a low-power reference signal received power (LP-RSRP) of the first LP-SS. On a condition that the LP-RSRP of the first LP-SS is below a threshold, for each candidate LP-SS the WTRU: determines a spatial filter; receives the candidate LP-SS; and measures an LP-RSRP for the candidate LP-SS. On a condition that the LP-RSRP of all of the candidate LP-SSs in the set are below a threshold, and that a time duration until a next active time is equal to or higher than a time threshold, the WTRU transmits information indicating an out of range status.

### BACKGROUND

The use of a low-power-wake-up signal (LP-WUS) in new radio (NR) is the subject of ongoing research. The research is motivated by the potential promise of increased power savings and transmission efficiency of LP-WUS compared with convention wireless communications.

Monitoring of an LP-WUS has the potential to reduce power consumption of wireless transmit/receive units (WTRUs) and other small battery powered devices. This is achieved by using a separate ultra-low power consumption receiver which can monitor wake-up signals (WUSs) and trigger and/or wake-up the Main radio Receiver (MR) dedicated for data and control signal transmission/reception.

### SUMMARY

In a low-power-wake-up signal (LP-WUS) system, a wireless transmit/receive unit (WTRU) receives configuration information for a first low power synchronization signal (LP-SS) and a set of one or more candidate LP-SSs. Further, the first LP-SS and the set of one or more candidate LP-SSs are associated with an LP-WUS. The WTRU determines a spatial filter for receiving the first LP-SS. Also, the WTRU receives the first LP-SS using the determined spatial filter for receiving the first LP-SS. Accordingly, the WTRU measures a low-power reference signal received power (LP-RSRP) of the first LP-SS.

On a condition that the LP-RSRP of the first LP-SS is below a threshold, for each candidate LP-SS in the set of one or more candidate LP-SSs the WTRU: determines a respective spatial filter; receives the candidate LP-SS using the determined respective spatial filter; and measures a respective LP-RSRP for the candidate LP-SS. Moreover, on a condition that the LP-RSRP of all of the candidate LP-SSs in the set of one or more candidate LP-SSs are below a threshold, and that a time duration until a next active time is equal to or higher than a time threshold, the WTRU transmits information indicating an out of range status of the WTRU.

On a condition that the LP-RSRP of at least one of the first LP-SS or one of the candidate LP-SSs is equal to or above a threshold, the WTRU receives the LP-WUS; the WTRU also receives a physical downlink control channel (PDCCH) transmission; and the WTRU transmits an uplink (UL) transmission based on the PDCCH transmission. In an example, the WTRU receives the LP-WUS during a main radio (MR)-OFF mode. Additionally or alternatively, the WTRU receives the PDCCH during an MR-ON mode. Additionally or alternatively, the WTRU transmits the UL transmission during the MR-ON mode.

Additionally or alternatively, the WTRU receives configuration information for a set of one or more transmission configuration index (TCI) states during the MR-ON mode. Further, each TCI state is associated with a respective reference signal (RS). Also, the WTRU receives configuration information indicating a first TCI state, of the set of TCI states, associated with the LP-WUS during the MR-ON mode. Moreover, the WTRU determines a spatial filter for receiving the LP-WUS based on the indicated first TCI state, and the LP-WUS is received using the determined spatial filter for receiving the LP-WUS.

Additionally or alternatively, the respective RS is one of a synchronization signal block (SSB), channel state information-reference signal (CSI-RS), sounding reference signal (SRS), demodulation reference signal (DM-RS), tracking reference signal (TRS), positioning reference signal (PRS), or phase tracking-reference signal (PT-RS).

Additionally or alternatively, the spatial filter for receiving the first LP-SS is determined based on an indicated second TCI state. Additionally or alternatively, the respective spatial filter for each candidate LP-SS is determined based on a respective indicated TCI state. Additionally or alternatively, the spatial filter for receiving the first LP-SS or the respective spatial filter for receiving one of the candidate LP-SSs is determined based on an indicated third TCI state and an indicated fourth TCI state. Further, the determined spatial filter receiving the first LP-SS or the spatial filter for receiving one of the candidate LP-SSs is in between a spatial filter determined based on the third state and spatial filter determined based on the fourth TCI state.

Additionally or alternatively, the LP-RSRP of the first LP-SS is measured while the WTRU is in the MR-OFF mode. Further, the information indicating an out of range status of the WTRU is transmitted when the WTRU is in the MR-ON mode. Additionally or alternatively, a transceiver of the WTRU includes an MR and a low-power wake-up radio (LP-WUR).

Additionally or alternatively, the next active time is the next connected-mode discontinuous reception (C-DRX) active time. Additionally or alternatively, the WTRU receives a response indicating another TCI state.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example of a low-power wake-up receiver (LP-WUR) architecture;

FIG. 3 is a system diagram illustrating an example of low-power synchronization signal (LP-SS) beams and synchronization signal blocks (SSBs); and

FIG. 4 is a signaling diagram illustrating an example of spatial relations for LP-SSs.

### DETAILED DESCRIPTION

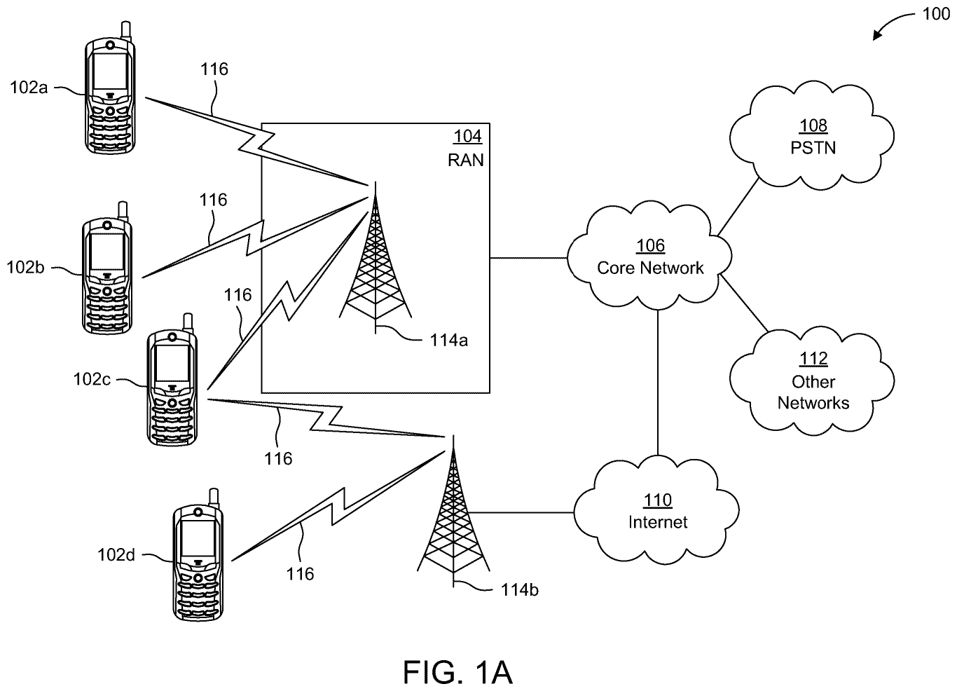

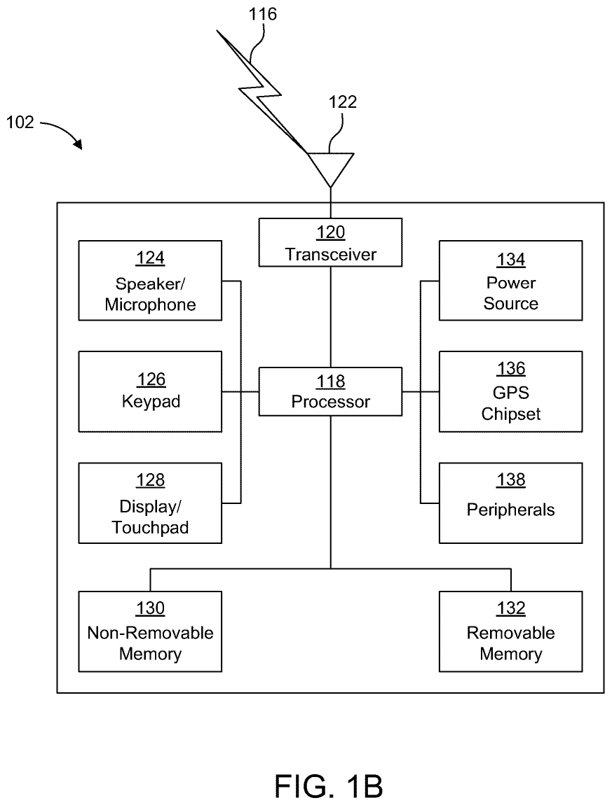

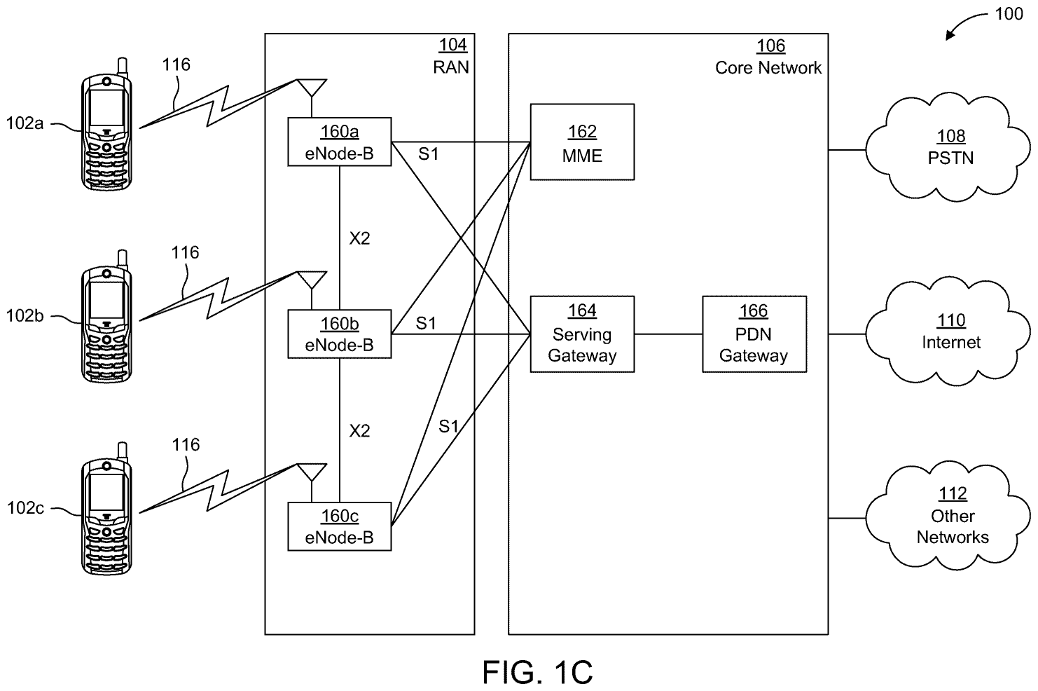

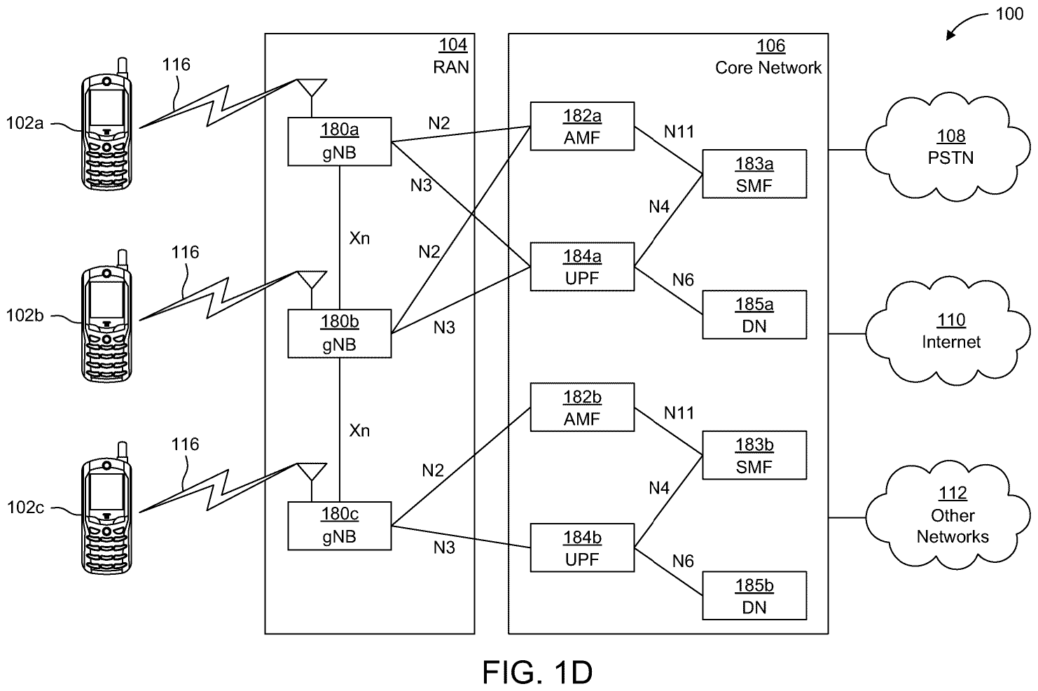

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

LP-WUS) in new radio (NR) is the subject of ongoing research. The research is motivated by the potential promise of increased power savings and transmission efficiency of LP-WUS compared with convention wireless communications.

Monitoring of a low-power-wake-up signal (LP-WUS) has the potential to reduce power consumption of wireless transmit/receive units (WTRUs) and other small battery powered devices. This is achieved by using a separate ultra-low power consumption receiver which can monitor wake-up signals (WUSs) and trigger and/or wake-up the Main radio Receiver (MR) dedicated for data and control signal transmission/reception.

An LP-WUS may be received by a WTRU such as WTRU 102, in an example. In a further example, an LP-WUS may be received by a WTRU which includes both a main receiver and a low-power receiver.

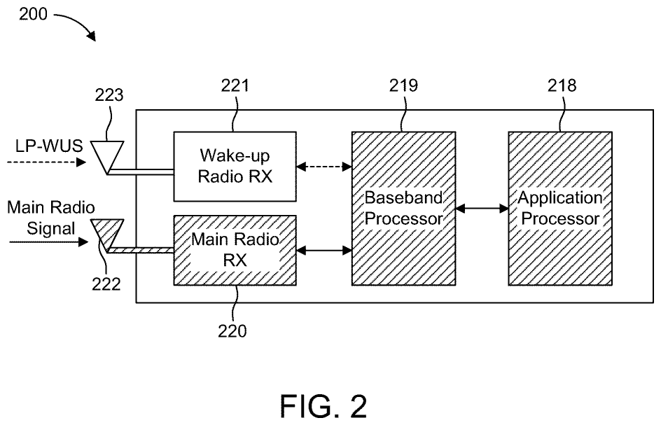

FIG. 2 is a system diagram illustrating an example of a low-power wake-up receiver (LP-WUR) architecture. As shown in system diagram 200, an ultra-low power consumption receiver, such as wake-up radio 221, can be separate from a main radio 220. In an example, wake-up radio 221 and main radio 220 may be separate functional blocks. The main radio 220 may receive a main radio signal via a main transmit/receive element 222. Further, the main radio 220 may be placed in a sleep or “OFF mode” to save power, and not be able to receive or monitor for the main radio signal during this time. During this time, the wake-up radio 221 may continue to be able to receive or monitor for a signal, such an LP-WUS, using a transmit/receive element 223. If the wake-up radio 221 receives an LP-WUS, it may then trigger, wake-up, or both, the main radio 220 for data and control signal transmission/reception. In an example, the main radio signal received by the main radio 220 may undergo baseband processing by a baseband processor 219. The baseband processor 219 may then provide an output, based on the processed main radio signal, to application processor 218, which may then use the output in an application. Similarly, the LP-WUS received by the wake-up radio 220 may undergo baseband processing by a baseband processor 219. The baseband processor 219 may then provide an output, based on the processed LP-WUS, to application processor 218, which may then use the output to wake-up the main radio. Additionally or alternatively, the application processor 218 may not be used in the process to wake-up the main radio, and the baseband processor 219 may send an output to the main radio 220 to wake-up main radio upon receiving the LP-WUS from wake-up radio 221.

Additionally or alternatively, the WTRU 102 may alternate between operating in an MR-ON mode and an MR-OFF mode. The MR-OFF mode may save power of the WTRU 102. The WTRU 102 may enter MR-ON mode upon receiving an LP-WUS.

In systems based on LP-WUS, the LP-WUR is configured with monitoring occasions to monitor and detect potential LP-WUSs. The LP-WUR could be configured with time resources (e.g., periodicity and offset) from a Network (NW). In NR, the time and frequency synchronization are based on receiving Synchronization Signal Blocks (SSBs) and using a Primary Synchronization Signal (PSS) and/or Secondary Synchronization Signal (SSS) for synchronization.

Compared to conventional NR, in systems based on LP-WUS, the WTRU could still receive the SSBs during MR's “ON mode”, where the WTRU could use the received SSB for synchronization. However, in cases where the WTRU is configured and/or indicated (e.g., in CONNECTED mode) or decided (e.g., in IDLE/INACTIVE modes) with activation of sleep modes (e.g., deep sleep or ultra deep sleep), the clock frequency could drift at the WTRU as the WTRU couldn't identify timing from the SSB. The clock frequency drift or frequency error could result in inaccuracy in LP-WUR's time/frequency synchronization. For example, the difference in the NW's clock and LP-WUR's clock frequency could result in a timing mismatch between the LP-WUS transmission time from the NW and LP-WUR's monitoring window. The timing mismatch could lead to a failed detection of the LP-WUS.

To avoid the timing mismatch between the LP-WUS transmission time from the NW and LP-WURs' monitoring occasions, the WTRU could be configured to detect and receive periodic Low Power Synchronization Signals (LP-SSs) to achieve accurate synchronization at the LP-WUR. In an example, an LP-SS could be based on On-Off Keying (OOK) symbols forming binary sequences, where the WTRUs with LP-WUS configurations could use LP-WUR (e.g., based on OOK receivers) to detect and receive the LP-SS. In another example, the LP-SS could be based on OFDM sequences (e.g., overlaid OFDM sequences over OOK symbols) where the WTRUs with LP-WUS configurations could use LP-WUR (e.g., based on OFDM receivers) to detect and receive the LP-SS, and so forth. In another example, the LP-SS may not be used by LP-WUR (e.g., based on OFDM sequences) where the WTRUs with an LP-WUS configuration could use an LP-WUR (e.g., based on OFDM receivers) to detect and receive an SSB.

LP-WUS systems can leverage beam-based frameworks for enhanced capacity, latency, coverage, and the like, where the LP-WUS sequences could be transmitted based on different beam directions and spatial relations. In NR, the UL/DL beam management can be handled based on frequent reporting from the WTRU and indicating the measured reference signal received power (RSRP) and/or one or more (best) beams (for example, with highest RSRP). In LP-WUS systems with potentially long wake-up cycles and/or long channel state information (CSI) reporting periodicities, a WTRU that is configured with a first LP-WUS beam direction could go out of range in between the two CSI reporting or wake up cycles (for example, due to WTRU's movement). WTRU could be receiving and monitoring one or more second LP-SSs; however, the reception of LP-WUS may be degraded based on the first configured LP-WUS beam direction. In this case, the base station that has sent LP-WUS to the WTRU based on the first LP-WUS direction could realize that WTRU is not responding to the transmitted LP-WUS. So, base station may retransmit the LP-WUS in different beam directions (for example, based on configured SSBs) for WTRU to receive the LP-WUS. Such “beam-sweeping” LP-WUS transmission could cause latency due to the time gap between different LP-WUS monitoring occasions configured based on different beam directions. Also, in case the LP-WUS is based on group-based signaling, transmission of LP-WUS for multiple times and different beam directions could result in repeated and unnecessary waking up of the other WTRUs that are in the same group, resulting in waste of power.

On the other hand, the beam-based LP-SS and LP-WUS may need to be specified with regards to (for example, NR) reference signals (RSs) (for example, SSB) and/or channels (for example, CORESET/Search Space) in spatial domain. In an example scenario, for LP-WUS monitoring, an LP-WUS may have quasi-colocation (QCL) Type-D relation with one or more LP-SSs. In another example scenario, for LP-WUS monitoring, an LP-WUS may have QCL Type-D relation with one or more (for example, NR) reference signals (RSs), channels, CORESET, and the like for the transmission configuration index (TCI) state. In this scenario, the LP-WUS Tx spatial filter may be based on TCI-states associated with NR RSs (for example, SSB) and/or channels. This may be due to compatibility with WTRUs whose LP-WUR is based on OFDM receivers and may only monitor SSBs and/or other NR RSs and/or channels.

Moreover, LP-SS beams could be considered in spatial domain, where the QCL relations between LP-SS beams and RSs and/or channels need to be identified. In an example scenario, the number of SSBs and LP-SSs may not be the same, the beamwidth of SSBs and LP-SSs may be different, and so forth.

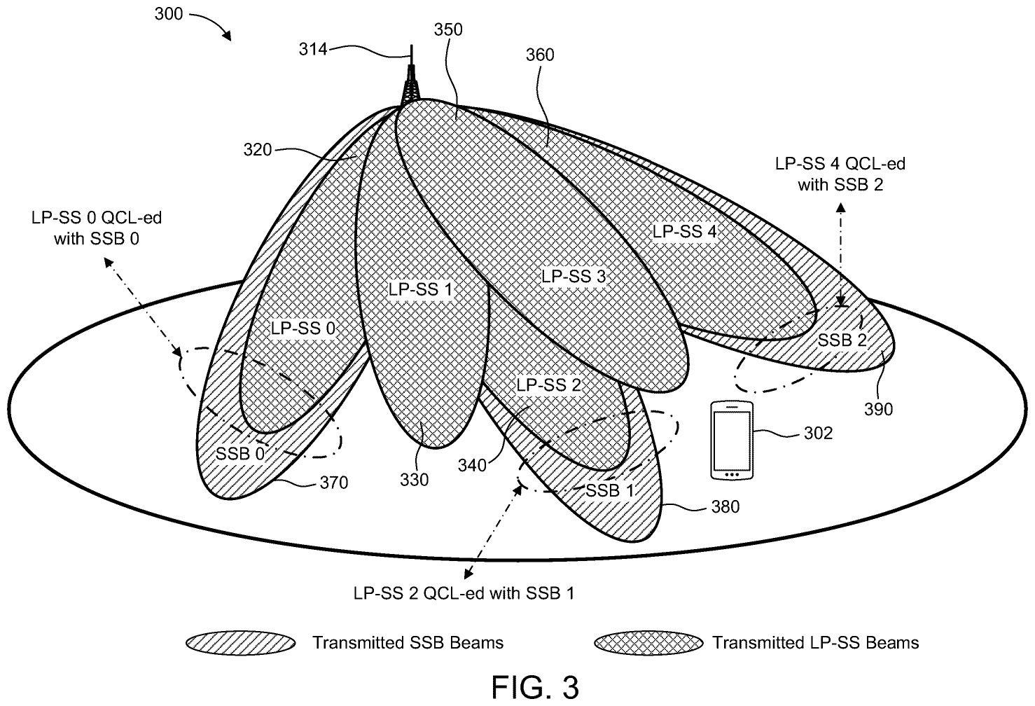

FIG. 3 is a system diagram illustrating an example of LP-SS beams and SSB beams. An example is shown in system diagram 300, where there are three SSB beams (for example, SSB 0 370, SSB 1 380, and SSB 2 390) and five LP-SS beams (for example, LP-SS 0 320, LP-SS 1 330, LP-SS 2 340, LP-SS 3 350, and LP-SS 4 360). The three SSB beams and five LP-SS beams may be transmitted by base station 314. FIG. 3 illustrates an example of LP-SS beam directions and the association of one or more of the LP-SSs with one or more SSBs.

In an example, base station 314 may be the same as or similar to base station 114a. Additionally or alternatively, base station 314 may be a gNB. A WTRU 302 may monitor for one or more of the beams. Additionally or alternatively, the WTRU 302 may receive one or more of the beams. In an example, WTRU 302 may be the same as or similar to WTRU 102.

In FIG. 3, LP-SS 0 320 has QCL-Type-D relationship with SSB 0 370; LP-SS 2 340 has QCL-Type-D relationship with SSB 1 380; and LP-SS 4 360 has QCL-Type-D relationship with SSB 2 390. That is, LP-SS 1 330 and LP-SS 3 350 do not have QCL Type-D relations with any of the configured SSBs.

In another example scenario, associated NR RSs/channels with LP-SSs may be turned off. Therefore, the QCL relationship between the NR RSs/channels and LP-SSs may not be applicable.

Accordingly, several problems may be articulated based on the above. For example, one problem includes what the WTRU behavior is if the WTRU moves out of range for reception of LP-WUS based on a configured beam direction. Further, another problem includes what the WTRU behavior is if an LP-SS does not have spatial relationship with one or more NR RSs and channels. A further problem includes what the WTRU behavior is if a spatial relationship between an LP-SS and one or more NR RSs and/or channels is not applicable. Additionally or alternatively, a problem includes how TCI-states are indicated for one or more LP-SS beams.

Embodiments and examples are provided herein of methods and apparatus determining spatial relations for one or more LP-SSs. In an example, a WTRU in RRC-CONNECTED mode and during MR-ON mode receives a first beam direction for LP-WUS monitoring that is associated with a first LP-SS beam direction. In an example, the first beam direction for LP-WUS monitoring is the best beam direction for LP-WUS monitoring. Additionally or alternatively, the first LP-SS beam direction is a best LP-SS beam direction. Further, the WTRU also receives a set of candidate LP-SSs that are associated with the indicated (for example, best) LP-WUS and/or LP-SS beam direction.

During MR-OFF mode, the WTRU monitors and measures the configured first LP-SS and/or the candidate LP-SSs and wakes up MR if WTRU is out of range (for example, spatial range) with regards to the configured LP-WUS beam direction. Additionally or alternatively, the WTRU monitors and measures the configured first LP-SS and/or the candidate LP-SSs and enters MR-ON mode if WTRU is out of range (for example, spatial range) with regards to the configured LP-WUS beam direction. That is, if a measured LP-RSRP for the first LP-SS and all candidate LP-SSs are lower than a corresponding RSRP threshold, and the time duration till next CSI reporting occasion is higher than a corresponding time threshold, then the WTRU enters MR-ON mode.

Specifically, a WTRU in RRC-CONNECTED mode is configured with a set of one or more TCI states (for example, associated with one or more NR RSs). Additionally or alternatively, the WTRU is configured with a first TCI state for a first LP-WUS (for example, configured as a QCL Type D) from among the set of one or more TCI states (for example, for LP-WUS reception). Further, the WTRU is configured with a first LP-SS (for example, via an LP-SS index)) that is associated with the first LP-WUS and a set one or more candidate LP-SSs that are associated with the first LP-WUS. In an example, the LP-SS may be used for radio resource management (RRM) measurements, synchronization, receiving LP-SS, and the like.

Additionally or alternatively, the WTRU is configured with a set of TCI states for each of the first LP-SS and one or more candidate LP-SSs, wherein each TCI state is associated with an NR RS. The WTRU determines spatial filter to receive and measure LP-SS, based on one or more of the following. For example, if the WTRU is configured with a single TCI-state for the first or a candidate LP-SS, the WTRU uses a spatial filter determined for the TCI-state for receiving the respective LP-SS.

Additionally or alternatively, if the WTRU is configured with more than one TCI-state for the first or a candidate LP-SS, the WTRU uses the configured TCI-states for determining the beam direction corresponding to the LP-SS, potentially in between the configured one or more TCI-states. An example of using more than one TCI-state for the first or a candidate LP-SS is shown below in Table 1. Table 1 shows an example of an association of an LP-SS with a wide beamwidth with TCI states.

TABLE 1

| LP-SS | NR-RS | Associated TCI states |
|---|---|---|
| LP-SS 1 | NR-RS0 | {TCI-state4} |
| | NR-RS1 | {TCI-state5} |

For example, in case two TCI-states are configured for an LP-SS, the WTRU may determine the spatial filter to receive LP-SS 1 to be spatially in the middle of the spatial filters used for receiving the two TCI-states. An example of two TCI-states configured for an LP-SS is shown in FIG. 3, where LP-SS 1 330 is in between SSB 0 370 and SSB 1 380.

Additionally or alternatively, if the WTRU is configured with a similar TCI-state or the same TCI-state, for more than one first or candidate LP-SSs, the WTRU uses spatial filter corresponding to the TCI-state for receiving the LP-SSs. An example of using the same TCI-state or similar TCI-state is shown below in Table 2. Table 2 shows an example of an association of LP-SSs with narrow beamwidth with one or more TCI states.

TABLE 2

| LP-SS | NR-RS | Associated TCI states |
|---|---|---|
| LP-SS 4 | NR-RS 10 | {TCI-state17} |
| LP-SS 5 | NR-RS 10 | {TCI-state17} |
| LP-SS 6 | NR-RS 10 | {TCI-state17} |

During the MR-OFF mode, the WTRU measures the first LP-SS based on the determined spatial filter and if the measured LP-RSRP is lower than a configured threshold, the WTRU then measures the one or more candidate LP-SSs. If the measured LP-RSRP for at least one of the candidate LP-SSs is equal to or higher than a corresponding threshold, the WTRU selects the candidate LP-SS and switches to the selected candidate LP-SS for monitoring, receiving, measuring, synchronization, and the like.

If the measured LP-RSRP for the first LP-SS and the candidate LP-SSs are lower than threshold, the WTRU determines that the WTRU is “out of range” with regards to LP-WUS beam direction, and the WTRU measures one or more other transmitted (for example, cell-common) LP-SSs and determines a second (for example, best) LP-SS, for example, with the highest measured LP-RSRP, and associated second TCI state (for example, based on configured sets of TCI-states for the second LP-SS).

The WTRU determines whether to wake up MR (for example, to indicate the “out of range” status and second LP-SS TCI-state) based on time duration till upcoming connected mode discontinuous reception (C-DRX) active time. For example, in case the time duration till the next C-DRX active time, where the WTRU is configured to wake up MR (for example, to receive an SPS DL, and the like; or, for example, to send a configured UL, CSI reporting, a scheduling request (SR), and the like), is longer than a time threshold, the WTRU wakes up MR and sends an indication of “out of range” status and second LP-SS TCI-state.

Additionally or alternatively, the WTRU potentially receives a response from the base station (for example, via receiving a physical downlink control channel (PDCCH) in an associated CORESET/SS). The response may confirm the indicated 2nd TCI state or include a third TCI state for LP-WUS and/or LP-SS reception. If the WTRU receives the response, the WTRU deactivates MR and goes back to sleep/MR-OFF mode (for example, deep sleep). The WTRU uses the confirmed second TCI state or the indicated 3rd TCI state for LP-WUS and/or LP-SS reception.

Additionally or alternatively, the WTRU uses the second TCI state for LP-WUS and/or LP-SS reception and goes into MR-OFF mode.

As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’ herein. The term ‘may’ is to be interpreted as ‘may, for example’ as used herein. A symbol ‘/’ (for example, forward slash) may be used to represent ‘and/or’, where for example, ‘A/B’ may imply ‘A and/or B’ herein.

Herein, the terms prediction and estimation may be used interchangeably, but still consistent with embodiments and examples herein. Herein, the terms candidate cell, neighbor cell, and target cell may be used interchangeably, but still consistent with embodiments and examples herein. Herein, the terms source cell, current cell, and serving cell may be used interchangeably, but still consistent with embodiments and examples herein.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target” and the received RS or SS block may be referred to as “reference” or “source.” In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by radio resource control (RRC) or signaled by a MAC control element (CE) or downlink control information (DCI). For example, a WTRU may implicitly transmit a physical uplink shared channel (PUSCH) and demodulation reference signal (DM-RS) of PUSCH according to the same spatial domain filter as an sounding reference signal (SRS) indicated by an SRS resource indicator (SRI) indicated in DCI or configured by RRC signaling. In another example, a spatial relation may be configured by RRC for an SRI or signaled by a MAC CE for a physical uplink control channel (PUCCH). Such spatial relation may also be referred to as a “beam indication” in examples.

The WTRU may receive a first (target) downlink channel or signal according to the same spatial domain filter or spatial reception parameter as a second (reference) downlink channel or signal. For example, such association may exist between a physical channel such as a PDCCH or physical downlink shared channel (PDSCH) and its respective DM-RS. At least when the first and second signals are reference signals, such association may exist when the WTRU is configured with a QCL assumption type D between corresponding antenna ports. Such association may be configured as a TCI state. A WTRU may be indicated with an association between a CSI-RS or SS block and a DM-RS by an index to a set of TCI states configured by RRC and/or signaled by MAC CE. Such indication may also be referred to as a “beam indication” in examples.

Herein, a beam resource may consist of a TCI state, CSI-RS, a DL RS, or an SSB for downlink; and an SRS resource, an UL RS, or TCI state for uplink. A beam resource may be identified by a beam indication.

Hereafter, a transmission and reception point (TRP) may be interchangeably used with one or more of a transmission point (TP), reception point (RP), radio remote head (RRH), distributed antenna (DA), base station (BS), a sector (of a BS), and a cell (for example, a geographical cell area served by a BS), but still consistent with embodiments and examples herein. Hereafter, a multi-TRP may be interchangeably used with one or more of MTRP, M-TRP, and multiple TRPs, but still consistent with embodiments and examples herein.

A WTRU may report a subset of CSI components, where CSI components may correspond to at least a CSI-RS resource indicator (CRI), an SSB resource indicator (SSBRI), an indication of a panel used for reception at the WTRU (such as a panel identity or group identity), measurements such as L1-RSRP, L1-SINR taken from SSB or CSI-RS (for example cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

Examples provided herein include channel measurements, interference measurements, or both. A WTRU may receive a synchronization signal/physical broadcast channel (SS/PBCH) block. The SSB may include a PSS, SSS, and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: a CSI Report Configuration, a CSI-RS Resource Set, or non-zero-power CSI-RS (NZP CSI-RS) Resources. The CSI Report Configuration may include one or more of the following: CSI report quantity, for example, CQI, RI, PMI, CRI, LI, and the like; CSI report type, for example, aperiodic, semi persistent, periodic; CSI report codebook configuration, for example, Type I, Type II, Type II port selection, and the like; or CSI report frequency. The CSI-RS Resource Set may include one or more of the following CSI Resource settings: NZP-CSI-RS Resource for channel measurement; NZP-CSI-RS Resource for interference measurement; or CSI-IM Resource for interference measurement. The NZP CSI-RS Resources, may include one or more of the following: NZP CSI-RS Resource identifier (ID); Periodicity and offset; QCL Info and TCI-state; or resource mapping, for example, number of ports, density, code divisional multiplexing (CDM) type, and the like.

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

A synchronization signal reference signal received power (SS-RSRP) may be measured based on the synchronization signals (for example, DM-RS in PBCH or SSS). It may be defined as the linear average over the power contribution of the resource elements (REs) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the REs that carry the respective CSI-RS. The CSI-RSRP measurement may be configured within measurement resources for the configured CSI-RS occasions.

SS signal-to-noise and interference ratio (SS-SINR) may be measured based on the synchronization signals (for example, DM-RS in PBCH or SSS). It may be defined as the linear average over the power contribution of the RE that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the REs that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (for example, co-channel serving and non-serving cells, adjacent channel interference, thermal noise, and so forth).

Cross-Link interference received signal strength indicator (CLI-RSSI) may be measured based on the average of the total power contribution in configured OFDM symbols of the configured time and frequency resources. The power contribution may be received from different resources (for example, cross-link interference, co-channel serving and non-serving cells, adjacent channel interference, thermal noise, and so forth).

SRS-RSRP may be measured based on the linear average over the power contribution of the REs that carry the respective SRS.

Secondary synchronization signal reference signal received quality (SS-RSRQ) may be measured based on measurements on the SS-RSRP and RSSI. In an example, the SS-RSRQ may be calculated as the ratio of N×SS-RSRP/NR carrier RSSI, where N may be determined based on the number of resource blocks that are in the corresponding NR carrier RSSI measurement bandwidth. As such, the measurements to be used in the numerator and denominator may be over the same set of resource blocks.

CSI-RSRQ. CSI reference signal received quality (CSI-RSRQ) may be measured based on measurements on the reference signal received power (CSI-RSRP) and received signal strength (RSSI). In an example, the SS-RSRQ may be calculated as the ratio of N×CSI-RSRP/CSIRSSI, where N may be determined based on the number of resource blocks that are in the corresponding CSI-RSSI measurement bandwidth. As such, the measurements to be used in the numerator and denominator may be over the same set of resource blocks.

Examples of a beam/CSI report configuration are provided herein. A CSI report configuration (for example, CSI-ReportConfigs) may be associated with a single bandwidth part (BWP) (for example, indicated by BWP-Id), wherein one or more of the following parameters are configured: CSI-RS resources and/or CSI-RS resource sets for channel and interference measurement; CSI-RS report configuration type including the periodic, semi-persistent, and aperiodic; CSI-RS transmission periodicity for periodic and semi-persistent CSI reports; CSI-RS transmission slot offset for periodic, semi-persistent and aperiodic CSI reports; CSI-RS transmission slot offset list for semi-persistent and aperiodic CSI reports; Time restrictions for channel and interference measurements; Report frequency band configuration (wideband/subband CQI, PMI, and so forth); Thresholds and modes of calculations for the reporting quantities (CQI, RSRP, SINR, LI, RI, and the like); Codebook configuration; Group based beam reporting; CQI table; Subband size; Non-PMI port indication; Port Index; and so forth.

Examples of a CSI-RS resource configuration are provided herein. A CSI-RS Resource Set (for example, an NZP-CSI-RS-ResourceSet) may include one or more of CSI-RS resources (for example, an NZP-CSI-RS-Resource and a CSI-ResourceConfig), wherein a WTRU may be configured with one or more of the following in a CSI-RS Resource: CSI-RS periodicity and slot offset for periodic and semi-persistent CSI-RS Resources; CSI-RS resource mapping to define the number of CSI-RS ports, density, CDM-type, OFDM symbol, and subcarrier occupancy; The BWP to which the configured CSI-RS is allocated; or the reference to the TCI-State including the QCL source RS(s) and the corresponding QCL type(s).

One or more of the following configurations may be used for an RS resource set. A WTRU may be configured with one or more RS resource sets. The RS resource set configuration may include one or more of following: a RS resource set ID; One or more RS resources for the RS resource set; Repetition (i.e., on or off); Aperiodic triggering offset (for example, one of 0-6 slots); or tracking reference signal (TRS) information (for example, true or not).

One or more of the following configurations may be used for an RS resource. A WTRU may be configured with one or more RS resources. The RS resource configuration may include one or more of following: RS resource ID; Resource mapping (for example, REs in a physical resource block (PRB)); Power control offset (for example, one value of −8, . . . , 15); Power control offset with SS (for example, −3 dB, 0 dB, 3 dB, 6 Db); Scrambling ID; Periodicity and offset; or QCL information (for example, based on a TCI state).

In the following, a property of a grant or assignment may consist of at least one of the following: A frequency allocation; An aspect of time allocation, such as a duration; A priority; A modulation and coding scheme; A transport block size; A number of spatial layers; A number of transport blocks; A TCI state, CRI or SRI; A number of repetitions; Whether the repetition scheme is Type A or Type B; Whether the grant is a configured grant type 1, type 2 or a dynamic grant; Whether the assignment is a dynamic assignment or a semi-persistent scheduling (configured) assignment; A configured grant index or a semi-persistent assignment index; A periodicity of a configured grant or assignment; A channel access priority class (CAPC); or any parameter provided in a DCI, by MAC or by RRC signaling for the scheduling the grant or assignment.

In the following, an indication by DCI may consist of at least one of the following: An explicit indication by a DCI field or by a radio network identifier (RNTI) used to mask or scramble the cyclic redundancy check (CRC) of the DCI; An implicit indication by a property such as DCI format, DCI size, Coreset or search space, Aggregation Level, first resource element of the received DCI (for example, index of first Control Channel Element), where the mapping between the property and the value may be signaled by RRC or MAC.

Receiving or monitoring for a DCI with or using an RNTI may mean that the CRC of the DCI is masked or scrambled with the RNTI.

Examples are provided herein of properties of an SR. The WTRU may use an SR for requesting UL-shared channel (SCH) resources for a new transmission. The WTRU may use the SR for sending one or more requests, indications, and/or reports, for example to a base station. The WTRU may be configured with zero, one, or more SR configurations. An SR configuration may consist of a set of PUCCH resources for the SR across different BWPs and/or cells. In an example, the WTRU may be configured with at most one PUCCH resource for the SR per BWP, for example for a logical channel or for secondary cell (SCell) beam failure recovery and/or for consistent listen-before-talk (LBT) failure recovery. In another example, the WTRU may be configured with for example up to two PUCCH resources for SR per BWP, for example for beam failure recovery of beam failure detection (BFD)-RS set(s) of Serving Cell.

For example, each SR configuration may correspond to one or more logical channels, SCell beam failure recovery, consistent LBT failure recovery, beam failure recovery of a BFD-RS set, and so forth. In an example, each logical channel, SCell beam failure recovery, beam failure recovery of a BFD-RS set and consistent LBT failure recovery, may be mapped to zero or one SR configuration, which may be configured via RRC signaling.

Hereafter, a signal may be interchangeably used with one or more of following, but still consistent with embodiments and examples herein: SRS; CSI-RS; DM-RS; Phase tracking reference signal (PT-RS); or SSB.

Hereafter, a channel may be interchangeably used with one or more of following but still consistent with embodiments and examples herein: PDCCH; PDSCH; PUCCH; PUSCH; Physical random access channel (PRACH); and the like.

A WTRU may be operating during at least one of the one or more RRC states and/or RRC modes, for example including RRC-Connected state, RRC-Inactive state, and/or RRC-Idle state.

A WTRU may be operating in an RRC-Connected state, during which the WTRU may have connected or established RRC context, and/or have at least one RRC connection, for example, to one or more cells, base stations, gNBs, TRPs, and the like. In RRC-Connected state, the WTRU may receive RRC context and/or one or more configuration information at least including one or more radio bearers, logical channels, PDU sessions, security information, and the like. During RRC-Connected state, the connected WTRU may measure one or more of RSRP, RSRQ, RSSI, and the like based on one or more received, detected, configured, and/or indicated RSs received from a serving cell and/or one or more neighboring cells. The connected WTRU may report the measured parameters, for example, to the serving cell.

Hereafter, a signal, channel, and message (for example, as in DL or UL signal, channel, and message) may be used interchangeably, but still consistent with embodiments and examples herein. Hereafter, RS may be interchangeably used with one or more of RS resource, RS resource set, RS port and RS port group, but still consistent with embodiments and examples herein. Additionally or alternatively, RS may be interchangeably used with one or more of SSB, CSI-RS, SRS, and DM-RS, TRS, positioning reference signal (PRS), and PT-RS, but still consistent with embodiments and examples herein. Additionally or alternatively, an RS resource set may be interchangeably used with a beam group, but still consistent with embodiments and examples herein.

Herein, time instance, slot, symbol, time unit, and subframe may be used interchangeably, but still consistent with embodiments and examples herein. Herein, the terms SSB, SS/PBCH block, PSS, SSS, PBCH, and master information block (MIB) may be used interchangeably, and still consistent with embodiments and examples herein. Additionally or alternatively, SSB, SSB beam, and SSB index may be used interchangeably, but still consistent with embodiments and examples herein.

Hereafter, the proposed solutions may be used for transmissions and/or receptions belonging to a single or multiple cells, inter-cell, intra-cell, as well as single or multiple TRPs, and still consistent with embodiments and examples herein. Hereafter, CSI reporting may be interchangeably used with CSI measurement, beam reporting and beam measurement, but still consistent with embodiments and examples herein.

Herein, RSRP may be used interchangeably with RSSI, RSRQ, signal-to-noise ratio (SNR), SS-RSRP, CSI-RSRP, SRS-RSRP, RSRP measured based on DM-RS in PBCH, RSRP measured based on DM-RS in PDCCH, RSRP measured based on DM-RS in PDSCH, RSRP measured based on DM-RS in PUCCH, RSRP measured based on DM-RS in PUSCH, Low-Power RSRP (LP-RSRP), LP-RSRQ, and so forth, and still consistent with embodiments and examples herein.

The solutions provided in this disclosure are based on LP-RSRP or RRM measurements based on detected, received, decoded, and/or measured LP-SS (sequences). The same solutions may be used for scenarios with RRM measurements based on one or more reference signals that may be received, detected, and/or measured via or as part of one or more LP-WUS transmissions, for example, via LP-WUR. Herein, reference signal (RS) may be substituted for LP-SS or LP-SS sequence and still be consistent with the embodiments and examples described herein.

In systems based on LP-WUS, the WTRU could receive the SSBs during a MR's “ON mode”, where the WTRU could use the received SSB for synchronization. However, in cases where the MR is configured with a long “OFF mode” or sleeping periods, the clock frequency could drift at the WTRU. The clock frequency drift or frequency error could result in inaccuracy in an LP-WUR's duty cycle. The difference in the NW's clock and LP-WUR's clock frequency could result in time mismatch between the LP-WUS transmission time from the NW and the LP-WUR's monitoring window. The time mismatch could lead to failed detection of an LP-WUS.

To avoid the time mismatch between the LP-WUS transmission time from the NW and the LP-WURs monitoring window, the WTRU could be configured to detect and receive periodic LP-SSs to achieve accurate synchronization at the LP-WUR. The LP-SS could be based on OOK symbols forming binary sequences, where the WTRUs with LP-WUS configurations could use LP-WUR (for example, based on OOK receivers) to detect and receive one or more LP-SSs.

The WTRU can use the detected, received, and/or measured LP-SS for time and frequency synchronization with one or more of the serving cell or neighbor cell. Moreover, the WTRU can use the detected, received, and/or measured LP-SS for RRM measurement. As such, the NW can configure the LP-SS sequence associated with the serving cell in addition to a number of candidate LP-SS sequences associated with one or more neighbor cells, where the WTRU can measure RRM measurements accordingly, for the serving cell and configured one or more neighbor cells, respectively.

A WTRU may monitor and receive a WUS via a first radio (for example, a low-power or ultra-low power radio). The WUS may be called an LP-WUS. The first radio may be called a low-power radio (LR) or a low-power wake-up radio (LP-WUR). Receiving a WUS (for example, an LP-WUS), for example via the LR, may trigger wake-up or usage of a second radio of the WTRU (for example, the WTRU's main radio (MR)) for data and/or control signal transmission and/or reception. This has the potential to reduce the power consumption of wireless devices. Additionally or alternatively, a WTRU may transition from a low power mode to a high power mode upon reception of a WUS.

LP-WUS/LP-WUR for NR is focused on supporting a deep sleep state for the MR while the WTRU is in RRC IDLE or RRC INACTIVE states (referred to as IDLE/INACTIVE mode LP-WUS monitoring) and supporting the WTRU to skip monitoring PDCCH while in RRC CONNECTED state (referred to as CONNECTED mode LP-WUS monitoring).

Discontinuous reception (DRX) is used to reduce WTRU power consumption by allowing the WTRU to periodically enter in to a ‘power saving state’ (DRX inactive) during which WTRU suspends at least PDCCH monitoring. Further, the WTRU can be configured to suspend one or more additional operations (for example, transmitting (for example, periodic) CSI reports, L1-RSRP reports and the like) during DRX inactive time. To monitor and receive PDCCHs which may schedule possible DL/UL data/control transmissions, the WTRU switches to an ‘active state’ for a limited time (DRX active time). During the ‘active state’, the WTRU may also be configured to perform one or more dynamic and/or configured UL/DL transmissions/receptions, including for example SRS transmission, CSI reporting, and the like. Once determined, scheduled, and/or configured UL/DL data and/or control transmissions and/or receptions are complete, the WTRU returns to the ‘power saving state.’

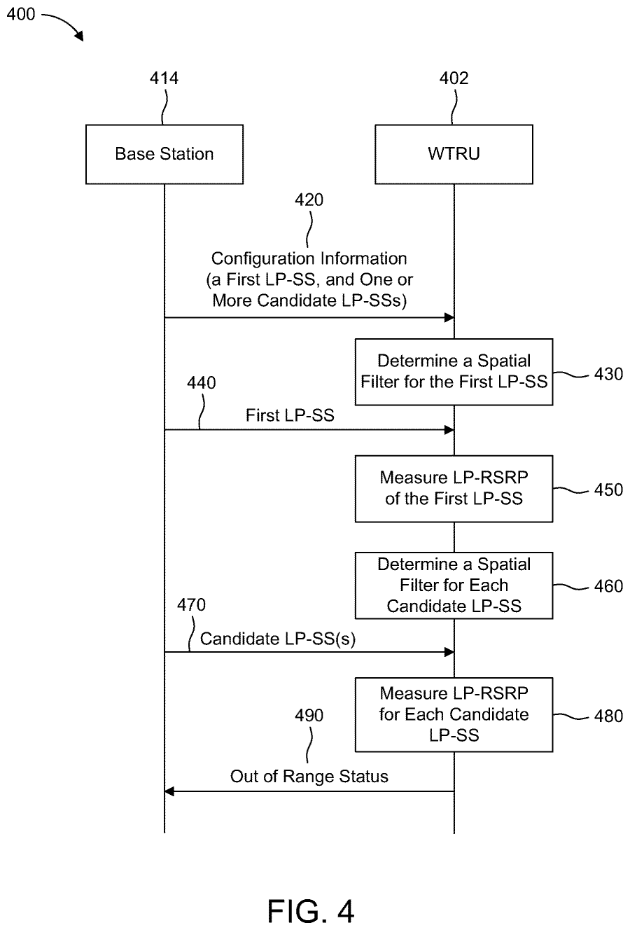

FIG. 4 is a signaling diagram illustrating an example of spatial relations for LP-SSs. As shown in an example in signaling diagram 400, a WTRU 402 may receive configuration information 420 from a base station 414. In an example, base station 414 may be the same as or similar to base station 114a. Additionally or alternatively, base station 414 may be a gNB. In an example, the WTRU 402 may be the same as or similar to WTRU 102.

The configuration information 420 is for a first LP-SS and a set of one or more candidate LP-SSs. Further, the first LP-SS and the set of one or more candidate LP-SSs are associated with an LP-WUS. The WTRU 402 determines a spatial filter for receiving the first LP-SS 430. Also, the WTRU 402 receives the first LP-SS 440 using the determined spatial filter for receiving the first LP-SS. Accordingly, the WTRU 402 measures an LP-RSRP of the first LP-SS 450.

On a condition that the LP-RSRP of the first LP-SS is below a threshold, for each candidate LP-SS in the set of one or more candidate LP-SSs the WTRU 402: determines a respective spatial filter 460; receives the candidate LP-SS 470 using the determined respective spatial filter; and measures a respective LP-RSRP for the candidate LP-SS 480. Moreover, on a condition that the LP-RSRP of all of the candidate LP-SSs in the set of one or more candidate LP-SSs are below a threshold, and that a time duration until a next active time is equal to or higher than a time threshold, the WTRU 402 transmits information indicating an out of range status 490 of the WTRU 402.

On a condition that the LP-RSRP of at least one of the first LP-SS or one of the candidate LP-SSs is equal to or above a threshold, the WTRU receives the LP-WUS; the WTRU also receives a PDCCH transmission; and the WTRU transmits a UL transmission based on the PDCCH transmission. In an example, the WTRU receives the LP-WUS during an MR-OFF mode. Additionally or alternatively, the WTRU receives the PDCCH during an MR-ON mode. Additionally or alternatively, the WTRU transmits the UL transmission during the MR-ON mode.

Additionally or alternatively, the WTRU receives configuration information for a set of one or more TCI states, during the MR-ON mode. Further, each TCI state is associated with a respective RS. Also, the WTRU receives configuration information indicating a first TCI state, of the set of TCI states, associated with the LP-WUS during the MR-ON mode. Moreover, the WTRU determines a spatial filter for receiving the LP-WUS based on the indicated first TCI state, and the LP-WUS is received using the determined spatial filter for receiving the LP-WUS.

Additionally or alternatively, the respective RS is one of an SSB, CSI-RS, SRS, DM-RS, TRS, PRS, or PT-RS.

Additionally or alternatively, the spatial filter for receiving the first LP-SS is determined based on an indicated second TCI state. Additionally or alternatively, the respective spatial filter for each candidate LP-SS is determined based on a respective indicated TCI state. Additionally or alternatively, the spatial filter for receiving the first LP-SS or the respective spatial filter for receiving one of the candidate LP-SSs is determined based on an indicated third TCI state and an indicated fourth TCI state. Further, the determined spatial filter receiving the first LP-SS or the spatial filter for receiving one of the candidate LP-SSs is in between a spatial filter determined based on the third state and spatial filter determined based on the fourth TCI state.

Additionally or alternatively, the LP-RSRP of the first LP-SS is measured while the WTRU is in the MR-OFF mode. Further, the information indicating an out of range status of the WTRU is transmitted when the WTRU is in the MR-ON mode. Additionally or alternatively, a transceiver of the WTRU includes an MR and an LP-WUR.

Additionally or alternatively, the next active time is the next C-DRX active time. Additionally or alternatively, the WTRU receives a response indicating another TCI state.

Examples are provided herein of spatial relations for an LP-SS. Further, examples are provided herein of configuration of spatial relations for an LP-SS.

A WTRU may be in RRC-Connected state and/or mode, where the WTRU may determine, receive, be configured, and/or indicated with one or more of configuration information and indications regarding a set of TCI-states. In an example, the configured and/or indicated TCI states may be associated with one or more NR RSs (for example, SSB, CSI-RS, TRS, and the like). For example, the WTRU may receive the set of TCI states via SIB, RRC signaling, MAC-CE, DCI, and the like.

The WTRU may be configured with one or more of configuration information and indications regarding one or more LP-WUSs. For example, the WTRU may be configured and/or indicated with one or more LP-WUS indexes, sequences, time and frequency resources, receiver type to be used (for example, OFDM LP-WUR, OOK LP-WUR, and the like) for reception of the configured LP-WUSs, and so forth. Moreover, the WTRU may determine, be configured, and/or indicated with one or more configuration information regarding spatial relations for receiving one or more LP-WUSs. For example, the WTRU may receive the configuration information on LP-WUSs via SIB, RRC signaling, MAC-CE, DCI, and the like.

In an example, the WTRU may receive, determine, be configured, and/or indicated with a first TCI state that may be associated with a first configured and/or indicated LP-WUS. For example, the first LP-WUS may be associated as a QCL Type D with the first TCI state. In an example, the WTRU may use the spatial filters determined and/or associated with the configured first TCI-state for receiving the first configured LP-WUS. In an example, the WTRU may be indicated with a first LP-WUS index corresponding to the first configured LP-WUS.

The WTRU may determine, receive, be configured, and/or indicated with the configuration of one or more LP-SSs that may be transmitted. For example, the configurations may be regarding the LP-SSs that may be transmitted, for example, from a base station, NW, Node-B, gNB, cell, and the like. In an example, the configuration may include the total number of LP-SSs transmitted and/or configured, for example at the base station side. The WTRU may alternatively or in addition receive a list of LP-SS indexes, that may correspond to an indexed set or subset of LP-SSs that may be configured and/or transmitted. For example, the WTRU may receive the number, list or subset of transmitted LP-SSs via SIB, RRC, MAC-CE, DCI signaling, and the like. In an example, the WTRU may receive the indication of the list or subset of LP-SSs using a bitmap, for example, where each bit indicates whether the corresponding LP-SS index is transmitted or not. For example, the size of the bitmap may be the total number of configured LP-SSs. In an example, the WTRU may receive one or more indications on transmitted LP-SS indexes, where the WTRU may update its configuration based on received indications. In an example, the WTRU may receive one or more indications on the total number of configured and/or transmitted LP-SSs, list or subset of transmitted LP-SSs, where the WTRU may update respective configuration based on the received indications.

The WTRU may be configured with one or more configuration information on one or more LP-SSs. For example, the WTRU may be configured and/or indicated with one or more LP-SS burst transmissions, corresponding transmitted LP-SS indexes, sequences, time and frequency resources, receiver type to be used (for example, OFDM LP-WUR, OOK LP-WUR, and the like) for reception of the configured LP-SSs, and so forth. For example, the WTRU may receive the configuration information on LP-SSs via SIB, RRC signaling, MAC-CE, DCI, and the like.

In an example, a WTRU may receive, determine, be configured, and/or indicated with a first LP-SS that may be associated with the configured and/or indicated first LP-WUS. For example, the indication and/or configuration may include the LP-SS index corresponding to the first LP-SS. For example, the WTRU may use the configured and/or indicated LP-SS configuration for reception of the first LP-SS, RRM measurements based on the first LP-SS, synchronization, and so forth. In an example, the WTRU may receive the configuration information on the first LP-SS via RRC signaling, MAC-CE, DCI, and the like.

In another example, a WTRU may receive, determine, be configured, and/or indicated with a set of candidate LP-SSs that may be associated with the configured and/or indicated first LP-WUS. For example, the indication and/or configuration may include the LP-SS index corresponding to the candidate LP-SSs. In an example, the WTRU may receive the configuration information on the set of candidate LP-SSs via RRC signaling, MAC-CE, DCI, and the like.

In an example solution, a WTRU may receive, determine, be configured, and/or indicated with one or more of configuration information or indications including at least a set of TCI states for each configured first LP-SS and candidate LP-SSs. The WTRU may determine the spatial filters to receive the LP-SSs based on the sets of TCI states. In an example, the configured TCI states may be associated with one or more NR RSs. In an example, the WTRU may receive the sets of TCI states for each first LP-SS or candidate LP-SSs based on respective LP-SS indexes. In another example, the WTRU may receive the sets of TCI states for all configured and/or transmitted LP-SSs, for example based on respective LP-SS indexes. For example, the WTRU may receive the configuration on sets of TCI states via RRC signaling, MAC-CE, DCI, and the like. The WTRU may determine the spatial filters to monitor, detect, receive, and/or measure LP-SSs, based on one or more of the following example associations and/or configurations: a single LP-SS associated with a single TCI state, a single LP-SS associated with more than one TCI-state, more than one LP-SS associated with a similar TCI state, and so forth.

In a single LP-SS associated with a single TCI state example, the WTRU may be configured with a first set of TCI-states associated with a first LP-SS, where the first set of TCI states may include a single first TCI state. As such, the WTRU may use the spatial filter configured, associated with, detected, and/or determined for reception of the first TCI state for receiving and/or measuring the first LP-SS.

In a single-SS associated with more than one TCI-state example, the WTRU may be configured with a second set of TCI-states associated with a second LP-SS, where the second set of TCI states may include more than one second TCI states. As such, the WTRU may use the spatial filter configured, associated with, detected, and/or determined for reception of the second TCI states for determining the spatial filter to monitor, receive, and/or measure the second LP-SS. In an example, the WTRU may use the configured second TCI-states for determining the beam direction and/or spatial filter corresponding to the LP-SS reception, for example, potentially in between the configured one or more second TCI-states.

For example, Table 1 above provides an example where LP-SS 1 is associated with two TCI-states and corresponding associated NR RSs. In this example, LP-SS 1 is associated with for example {TCI-state 4} and {TCI-state 5} that are associated, for example, with NR-RS0 and NR-RS1, respectively. For example, NR-RS0 and/or NR-RS1 may indicate an SSB, CSI-RS, TRS, and the like. In this example, the WTRU that has already determined the spatial filters and/or beam directions for receiving NR-RS0 and NR-RS1 may determine the spatial filter and/or beam direction for receiving LP-SS 1 based on the determined spatial filters, for example, in between them.

In a more than one LP-SSs associated with a similar TCI state example, the WTRU may be configured with more than one (for example, multiple) third LP-SSs that may be associated with a third TCI-state. As such, the WTRU may use the spatial filter configured, associated with, detected, and/or determined for reception of the third TCI state for monitoring, receiving, and/or measuring the third LP-SSs. For example, Table 2 above provides an example, where LP-SS 4, LP-SS 5, and LP-SS 6 are associated with a single TCI-state and corresponding associated NR RS. In this example, LP-SS 4, LP-SS 5, and LP-SS 6 are associated with for example {TCI-state 17} that is associated, for example, with NR-RS10. For example, NR-RS 10 may indicate an SSB, CSI-RS, TRS, and the like. In this example, the WTRU that has already determined the spatial filter and/or beam direction for receiving NR-RS 10 may use the determined spatial filter and/or beam direction for receiving LP-SS 4, LP-SS 5, and LP-SS 6.

Examples provided herein include an alternative indication of spatial relations for LP-SSs. A WTRU may receive, determine, be configured, and/or indicated with one or more of configuration information or indications regarding the TCI states for the transmitted and/or configured LP-SSs. In an example, the configured and/or indicated TCI states may use the reference to the configured RSs, that may be for example a set of SSBs, CSI-RS, TRS, and the like. For example, the WTRU may receive the configuration regarding TCI-states via SIB, RRC signaling, MAC-CE, DCI, and the like. In an example, the WTRU may receive the configuration for all the LP-SSs, or a subset of the LP-SSs or one or more specific LP-SS, for example, referred to with their LP-SS index(es). In another example, the WTRU may receive the configuration on the TCI states for one or more LP-SSs as an update of the configuration, where the update may indicate the TCI states to add or remove for a given LP-SS, for example, using RRC signaling, MAC-CE, DCI, and the like.

The WTRU may be configured by the network so that each LP-SS has one or more reference TCI state(s), as in examples Table 1 and Table 2. In an example, an LP-SS, indicated via its LP-SS index, may be associated with a single TCI state, for example, as QCL D relationship, for example with a configured and/or indicated RS (for example, an SSB, CSI-RS, TRS, and the like). In another example, an LP-SS may be associated with multiple TCI states, for example associated with different RSs (for example, SSBs, CSI-RSs, TRSs, and the like). In another example, multiple LP-SSs may be associated with a same TCI state, for example associated with a configured and/or indicated RS (for example, an SSB, CSI-RS, TRS, and the like).

In an example solution, a WTRU may explicitly receive the indication about the number (for example, R) of TCI state(s) for each LP-SS. Additionally or alternatively, the WTRU may determine that number based on the received configuration and/or association mapping. In an example, the WTRU may determine or receive the value R=1 for a first LP-SS, where there is one-to-one mapping between the corresponding LP-SS and a single TCI-state. In another example, the WTRU may determine or receive the value R higher than 1 (for example, R>1) for a second LP-SS, for example indicating a one-to-many association, where the second LP-SS may be associated with more than one TCI states. In another example, the WTRU may determine or receive the value R lower than one (for example, R<1) for a third LP-SS, for example indicating many-to-one association, where multiple LP-SSs may be associated with a configured TCI-state.

In an example, the WTRU may determine, receive, be configured, and/or indicated with a first value R for all or a subset of configured and/or transmitted LP-SSs. For example, the WTRU may receive the first value R via SIB, RRC signaling, MAC-CE, DCI, and the like. In another example, the WTRU may determine, receive, be configured, and/or indicated with a second value R for each configured and/or indicated LP-SSs. For example, the WTRU may receive the second value R via SIB, RRC signaling, MAC-CE, DCI, and the like. In an example, a first LP-SS may be configured with two TCI states corresponding to two different RSs, where the value R=2 may be configured and/or determined for the first LP-SS, see Table 1 as an example. In another example, a second LP-SS may be configured with a single TCI state, where the value R=1 may be configured and/or determined. In another example, a third, a fourth and a fifth LP-SS may be configured with a same TCI state, and the value R=⅓ may be configured and/or determined for each of the third, fourth, and fifth LP-SSs, see Table 2 as an example.

In a solution, a WTRU may report WTRU capabilities indicating respective LP-SS mapping restrictions. In an example, the WTRU may indicate WTRU's capability, where all LP-SSs may need to be configured in a similar way (for example, same R for all LP-SSs). In another example, the WTRU may indicate WTRU's capability, restricting the maximum number of TCI states for the configured LP-SSs. In another example, the WTRU may indicate WTRU's capability, restricting the maximum number of LP-SSs that may be configured with the same TCI state, and so forth.

Examples are provided herein of spatially out-of-range determination and indication. Further, examples of determining out-of-spatial-range is provided herein.

A WTRU may receive, determine, be configured, and/or indicated with one or more threshold values on one or more quality parameters. In an example, the WTRU may receive one or more threshold values on LP-RSRP measured based on one or more LP-SSs. As such, the WTRU may compare the measured LP-RSRP based on one or more received LP-SSs with corresponding configured threshold values.

In an example, the WTRU may measure a first LP-RSRP based on the configured first LP-SS, where the WTRU may use the determined spatial filter for monitoring, detecting, receiving, and/or measuring the first LP-SS. If the measured first LP-RSRP is lower than a corresponding configured threshold, the WTRU may measure one or more second LP-RSRPs based on one or more of the configured candidate LP-SSs. If the measured LP-RSRP based on at least one of the candidate LP-SSs is equal to or higher than a corresponding threshold, the WTRU may select the corresponding candidate LP-SS. In an example, the WTRU may switch the spatial filters used for LP-SS monitoring, receiving, measuring, synchronization, and the like to the determined spatial filters for the selected candidate LP-SS.

In an example solution, if the measured LP-RSRP based on the first LP-SS and the measured LP-RSRP based on the candidate LP-SSs are lower than corresponding thresholds, the WTRU may determine that the WTRU is “out of spatial range” with regards to the configured first LP-WUS beam direction and/or spatial range. The WTRU may determine that the WTRU is “out of spatial range” with regards to the configured first LP-WUS beam direction and/or spatial range if the measured LP-RSRPs for all the first LP-SS and candidate LP-SSs associated with the first LP-WUS are lower than corresponding configured thresholds.

In this case, the WTRU may measure other transmitted LP-SSs. In an example, the other transmitted LP-SSs may be configured based on cell-common configurations, for example via MIB, SIB, RRC signaling, MAC-CE, DCI, and the like. In another example, the other transmitted LP-SSs may be configured based on group-common configurations, for example via SIB, RRC signaling, MAC-CE, DCI, and the like. In another example, the other transmitted LP-SSs may be configured based on one or more (for example, WTRU-specific) configurations and/or indications, for example received via RRC signaling, MAC-CE, DCI, and the like.

In an example, the WTRU may select a second LP-SS, for which the WTRU may determine the spatial relation for LP-SS reception, measurement, and the like and/or an associated second TCI-state. For example, the WTRU may select the second LP-SS from all measured LP-SSs, where the measured LP-RSRP may be equal to or higher than a corresponding configured threshold. In an example, the WTRU may select the second LP-SS from all measured LP-SSs, for example with highest measured LP-RSRP. In an example, the WTRU may determine the second TCI-state associated with the second LP-SS based on configured sets of TCI-states for the second LP-SS.

Examples are provided herein of determining whether to wake up a WTRU, whether a WTRU should enter an MR-ON mode, whether to wake up an MR, or the like. In an example solution, a WTRU may determine resources, time instances, and/or timing to support one or more of the following WTRU operations: Wake up MR; Indicate “out of range” status and/or the second LP-SS TCI-state (for example, via transmission of one or more of SR, PUCCH, PUSCH, PRACH, one or more UL RSs (for example, SRS, UL DM-RS, UL PT-RS, and the like), and so forth); Monitoring PDCCH (for example, for paging and/or receiving DCI for scheduling and/or receiving an UL grant (for example, for PUSCH for the indication of “out of range” status in addition to the second LP-SS and/or associated second TCI state) or monitoring PDCCH may be done in associated one or more search spaces and/or CORESETs related to one or more of LP-WUS monitoring, paging, WTRU beam indication for LP-WUS, event triggered CSI and/or beam reporting, aperiodic CSI reporting, and the like.

The WTRU determination may be based on time duration and one or more time thresholds, where the WTRU may receive the time thresholds via RRC signaling, MAC-CE, DCI, and the like.

In an example solution, the time duration may be measured from one or more of the following: The WTRU determination; WTRU measurement of an RS (for example, an LP-SS); The RS for the measurement may be one or more of the second LP-SS, last LP-SS transmission and/or measurement (for example, before the WTRU determination) (for example, from a base station); or reception time instance of indication and/or update instance of a TCI state (for example, the TCI state for the first LP-SS).

In an example solution, the time duration may be measured until one or more of the following: Upcoming C-DRX active time (for example, start of drx-OnDurationTimer and/or C-DRX active time for wake up MR and/or UL resource for beam indication); Upcoming uplink resource for the indication; Upcoming CSI reporting and/or beam indication instance (for example, for periodic and/or semi-static CSI reporting); or upcoming PDCCH CORESET and/or SearchSpace for PDCCH reception (for example, for paging and/or DCI for scheduling UL resource).

For example, the time duration measurement may be in one or more of time units (for example, ns, us, ms), and/or based on the number of symbols, slots, frames, and the like. Based on the determined time duration, the WTRU may determine how to support WTRU operation, for example for one or more of waking up the MR, indication of “out of range” status, indication of the second LP-SS TCI state, and/or monitoring PDCCH.

For example, if the time duration, for example from WTRU determination till the next C-DRX active time, where the WTRU is configured to wake up MR, is longer than a configured time threshold, the WTRU may wake up MR and/or indicate “out of range” status and/or the second LP-SS (for example, associated with the second LP-SS TCI state), for example via a second LP-SS index, and/or the second LP-SS TCI state in a first resource. The first resource may be an uplink resource (for example, an upcoming uplink resource for one or more of UL RS, PUCCH, PUSCH and PRACH) after application of activation time (for example, from the WTRU determination and/or the WTRU measurement). The uplink resource may be an uplink resource before the upcoming C-DRX active time and/or periodic WTRU reporting resource. The first resource may be an uplink resource for semi-persistent and/or aperiodic CSI reporting.

In another example, if the time duration, for example from WTRU determination till the next C-DRX active time, where the WTRU is configured to wake up MR, is shorter than the time threshold, the WTRU may wake up MR and/or indicate “out of range” status, the second LP-SS (for example, associated with the second LP-SS TCI state), and/or the second LP-SS TCI-state in a second resource. The second resource may be an uplink resource (an uplink resource for one or more of UL RS, PUCCH, PUSCH and PRACH) in an upcoming C-DRX active time. The second resource may be an uplink resource for periodic and/or semi-persistent CSI reporting.

In another example, the WTRU may report the “out of range” status and/or the second LP-SS via an SR transmission. For example, the WTRU may use a specific SR for indication via a short or one-shot reporting.

In examples, a WTRU may trigger an event-based beam reporting based on one or more conditions and events. In an example, the WTRU may determine and/or detect that the quality (for example, LP-RSRP) of a first LP-SS and candidate LP-SSs corresponding to a first LP-WUS may be lower than a configured threshold and/or quality of a second LP-SS beam is higher than the configured threshold. As such, the WTRU may trigger an event-based beam reporting, for example to a base station. Based on the beam reporting, the WTRU may receive an indication of a TCI state for monitoring and receiving LP-WUS and/or LP-SS.

In an example, the WTRU may trigger an event-based beam reporting after waking up an MR. For example, the WTRU may report beam quality (for example, LP-RSRP) of one or more first, second, and/or candidate LP-SSs. In an example, the WTRU may transmit the report via preconfigured resources (for example, PUCCH, PUSCH). Additionally or alternatively, the WTRU may transmit the report by transmitting one or more UL signals and/or channels, that can be for example an SR, preconfigured PRACH resources, and the like In an example, the WTRU may determine, be configured, and/or indicated with the UL resources for transmission pf the report, for example via RRC signaling, MAC-CE, DCI, and the like. For example, the WTRU may receive an UL grant to transmit report.

In an example, after transmission of the report, for example including indication on “out of range” and/or second LP-SS, the WTRU may receive a response, for example from a base station. In an example, the WTRU may receive a DL signal and/or channel (for example, PDCCH) carrying the response, for example in preconfigured resources (for example, preconfigured CORESET and/or SS in a time window).

In an example, as part of the response, the WTRU may receive an indication confirming the second LP-SS and/or associated second TCI state for monitoring, receiving, measuring, and the like of one or more LP-SSs. In another example, as part of the response, the WTRU may receive an indication on a second LP-WUS TCI state for monitoring and/or reception of an LP-WUS. Moreover, the WTRU may receive, as part of the response, a third TCI state for LP-WUS and/or LP-SS reception. If the WTRU receives the response, the WTRU may deactivate the MR (for example, place the MR in a sleep state) and the WTRU may resume monitoring and/or receiving one or more signals and/or channels (for example, LP-SS, LP-WUS) via an LR. The WTRU may receive the LP-WUS and/or LP-SS via the LR based on the confirmed second LP-SS and/or TCI state. Additionally or alternatively, the WTRU may receive the LP-WUS and/or LP-SS via the LR based on the indicated third LP-SS and/or TCI state.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
receiving configuration information for a first low power synchronization signal (LP-SS) and a set of one or more candidate LP-SSs, wherein the first LP-SS and the set of one or more candidate LP-SSs are associated with a low-power-wake-up signal (LP-WUS);
determining a spatial filter for receiving the first LP-SS;
receiving the first LP-SS using the determined spatial filter for receiving the first LP-SS;
measuring a low-power reference signal received power (LP-RSRP) of the first LP-SS;
on a condition that the LP-RSRP of the first LP-SS is below a threshold, for each candidate LP-SS in the set of one or more candidate LP-SSs:
determining a respective spatial filter;
receiving the candidate LP-SS using the determined respective spatial filter; and
measuring a respective LP-RSRP for the candidate LP-SS; and
on a condition that the LP-RSRP of all of the candidate LP-SSs in the set of one or more candidate LP-SSs are below a threshold, and that a time duration until a next active time is equal to or higher than a time threshold, transmitting information indicating an out of range status of the WTRU.

2. The method of claim 1, further comprising:
on a condition that the LP-RSRP of at least one of the first LP-SS or one of the candidate LP-SSs is equal to or above a threshold:
receiving the LP-WUS, during a main radio (MR)-OFF mode;
receiving a physical downlink control channel (PDCCH) transmission, during an MR-ON mode; and
transmitting an uplink (UL) transmission based on the PDCCH transmission, during the MR-ON mode.

3. The method of claim 2, further comprising:
receiving configuration information for a set of one or more transmission configuration index (TCI) states, wherein each TCI state is associated with a respective reference signal (RS), during the MR-ON mode;
receiving configuration information indicating a first TCI state, of the set of TCI states, associated with the LP-WUS, during the MR-ON mode; and
determining a spatial filter for receiving the LP-WUS based on the indicated first TCI state, wherein the LP-WUS is received using the determined spatial filter for receiving the LP-WUS.

4. The method of claim 3, wherein the respective RS is one of a synchronization signal block (SSB), channel state information-reference signal (CSI-RS), sounding reference signal (SRS), demodulation reference signal (DM-RS), tracking reference signal (TRS), positioning reference signal (PRS), or phase tracking-reference signal (PT-RS).

5. The method of claim 1, wherein the spatial filter for receiving the first LP-SS is determined based on an indicated second TCI state.

6. The method of claim 1, wherein the respective spatial filter for each candidate LP-SS is determined based on a respective indicated TCI state.

7. The method of claim 1, wherein the spatial filter for receiving the first LP-SS or the respective spatial filter for receiving one of the candidate LP-SSs is determined based on an indicated third TCI state and an indicated fourth TCI state, wherein the determined spatial filter receiving the first LP-SS or the spatial filter for receiving one of the candidate LP-SSs is in between a spatial filter determined based on the third state and spatial filter determined based on the fourth TCI state.

8. The method of claim 1, wherein the LP-RSRP of the first LP-SS is measured while the WTRU is in the MR-OFF mode; and wherein the information indicating an out of range status of the WTRU is transmitted when the WTRU is in the MR-ON mode.

9. The method of claim 1, wherein the next active time is the next connected-mode discontinuous reception (C-DRX) active time.

10. The method of claim 1, further comprising:
receiving a response including another TCI state.

11. A wireless transmit/receive unit (WTRU) comprising:
a transceiver; and
a processor operatively coupled to the transceiver; wherein the transceiver and the processor are configure to:
receive configuration information for a first low power synchronization signal (LP-SS) and a set of one or more candidate LP-SSs, wherein the first LP-SS and the set of one or more candidate LP-SSs are associated with a low-power-wake-up signal (LP-WUS);
determine a spatial filter for receiving the first LP-SS;
receive the first LP-SS using the determined spatial filter for receiving the first LP-SS;
measure a low-power reference signal received power (LP-RSRP) of the first LP-SS;
on a condition that the LP-RSRP of the first LP-SS is below a threshold, for each candidate LP-SS in the set of one or more candidate LP-SSs:
determine a respective spatial filter;
receive the candidate LP-SS using the determined respective spatial filter; and
measure a respective LP-RSRP for the candidate LP-SS; and
on a condition that the LP-RSRP of all of the candidate LP-SSs in the set of one or more candidate LP-SSs are below a threshold, and that a time duration until a next active time is equal to or higher than a time threshold, transmit information indicating an out of range status of the WTRU.

12. The WTRU of claim 11, wherein the transceiver and the processor are further configure to:
on a condition that the LP-RSRP of at least one of the first LP-SS or one of the candidate LP-SSs is equal to or above a threshold:
receive the LP-WUS, during a main radio (MR)-OFF mode;
receive a physical downlink control channel (PDCCH) transmission, during an MR-ON mode; and
transmit an uplink (UL) transmission based on the PDCCH transmission, during the MR-ON mode.

13. The WTRU of claim 12, wherein the transceiver and the processor are further configure to:
receive configuration information for a set of one or more transmission configuration index (TCI) states, wherein each TCI state is associated with a respective reference signal (RS), during the MR-ON mode;
receive configuration information indicating a first TCI state, of the set of TCI states, associated with the LP-WUS, during the MR-ON mode; and
determine a spatial filter for receiving the LP-WUS based on the indicated first TCI state, wherein the LP-WUS is received using the determined spatial filter for receiving the LP-WUS.

14. The WTRU of claim 13, wherein the respective RS is one of a synchronization signal block (SSB), channel state information-reference signal (CSI-RS), sounding reference signal (SRS), demodulation reference signal (DM-RS), tracking reference signal (TRS), positioning reference signal (PRS), or phase tracking-reference signal (PT-RS).

15. The WTRU of claim 11, wherein the spatial filter for receiving the first LP-SS is determined based on an indicated second TCI state.

16. The WTRU of claim 11, wherein the respective spatial filter for each candidate LP-SS is determined based on a respective indicated TCI state.

17. The WTRU of claim 11, wherein the spatial filter for receiving the first LP-SS or the respective spatial filter for receiving one of the candidate LP-SSs is determined based on an indicated third TCI state and an indicated fourth TCI state, wherein the determined spatial filter receiving the first LP-SS or the spatial filter for receiving one of the candidate LP-SSs is in between a spatial filter determined based on the third state and spatial filter determined based on the fourth TCI state.

18. The WTRU of claim 11, wherein the transceiver includes an MR and a low-power wake-up radio (LP-WUR), wherein the LP-RSRP of the first LP-SS is measured while the WTRU is in the MR-OFF mode; and wherein the information indicating an out of range status of the WTRU is transmitted when the WTRU is in the MR-ON mode.

19. The WTRU of claim 11, wherein the next active time is the next connected-mode discontinuous reception (C-DRX) active time.

20. The WTRU of claim 11, wherein the transceiver and the processor are further configure to:
receive a response including another TCI state.
